(19) United States
(12) Patent Application Publication
(10) Pub. No.: US 2022/0345582 A1
(43) Pub. Date: Oct. 27, 2022

(54) READING DEVICE AND IMAGE FORMING APPARATUS

(71) Applicant: TOSHIBA TEC KABUSHIKI KAISHA, Tokyo (JP)

(72) Inventor: Takashi Shiraishi, Kawasaki Kanagawa (JP)

(21) Appl. No.: 17/685,417

(22) Filed: Mar. 3, 2022

(30) Foreign Application Priority Data
Apr. 21, 2021 (JP) 2021-071677

(51) Int. Cl. H04N 1/03; H04N 1/028

(52) U.S. Cl. CPC H04N 1/0306; H04N 1/02855

(57) ABSTRACT

According to an embodiment, a reading device that reads an object to be read in an image forming apparatus includes a lens array and a light guide. The lens array is provided in a posture in which an optical axis follows a height direction intersecting a reading surface. The light guide is adjacent to the lens array in a sub-scanning direction intersecting both the height direction and a main scanning direction, and locates maximum illuminance of illumination light illuminating the object to be read on a side opposite to the lens array with respect to a deepest position of a depth of field of the lens array in the height direction.

### CROSS-REFERENCE TO RELATED APPLICATION

This application is based upon and claims the benefit of priority from Japanese Patent Application No. 2021-071677, filed on Apr. 21, 2021, the entire contents of which are incorporated herein by reference.

### FIELD

Embodiments described herein relate generally to a reading device and an image forming apparatus.

### BACKGROUND

In an image forming apparatus, an object to be read is irradiated with light from a light source such as a light emitting device (LED) via a light guide, and thereby illuminance at a reading portion of the object to be read is set to predetermined illuminance. Accordingly, a reading device provided in the image forming apparatus can appropriately read the object to be read. For example, when a lens array is used in a reading optical system provided in the reading device, the object to be read and a reading surface may be separated. In this case, when illuminance when the object to be read and the reading surface are not separated (in contact with each other) is the same as illuminance when the object to be read is illuminated, optical efficiency of the lens array is lower than optical efficiency when the object to be read and the reading surface are not separated. As a result, illuminance of an image formed on a sensor surface by the lens array may decrease. Therefore, when the object to be read and the reading surface are separated, it is required to prevent a decrease in illuminance in an image in which light reflected by the object to be read is imaged on the sensor surface by the lens array.

### DESCRIPTION OF THE DRAWINGS

FIG. 1 is a schematic diagram of an image forming apparatus provided with a reading device according to an embodiment;

FIG. 2 is a schematic diagram showing a configuration of an image forming portion that forms a black image and a configuration of a periphery thereof;

FIG. 3 is a schematic diagram showing a configuration when the reading device is provided on a reading plate;

FIG. 4 is a schematic perspective view of a lens array;

FIG. 5 is a schematic diagram showing a configuration when the reading device is provided in a scanner unit; and

FIG. 6 is a schematic diagram showing a configuration when a reading device is provided on a reading plate.

### DETAILED DESCRIPTION

An aspect of an exemplary embodiment is to provide a reading device and an image forming apparatus capable of preventing a decrease in illuminance in an image in which light reflected by an object to be read is imaged on a sensor surface by a lens array when the object to be read and a reading surface are separated.

According to an embodiment, a reading device that reads an object to be read in an image forming apparatus includes a lens array and a light guide. The lens array is provided in a posture in which an optical axis follows a height direction intersecting a reading surface. The light guide is adjacent to the lens array in a sub-scanning direction intersecting both the height direction and a main scanning direction, and locates maximum illuminance of illumination light illuminating the object to be read on a side opposite to the lens array with respect to a deepest position of a depth of field of the lens array in the height direction.

Hereinafter, an embodiment will be described with reference to the drawings. In the embodiment, in an image forming apparatus 1, a direction along a gravity direction is described as a vertical direction (direction indicated by an arrow ZA and an arrow ZB), a direction along a longitudinal direction of a reading device is described as a depth direction (direction indicated by an arrow YA and an arrow YB), and a direction intersecting (orthogonal to or substantially orthogonal to) both the vertical direction and the depth direction is described as a width direction (direction indicated by an arrow XA and an arrow XB). A longitudinal direction of a reading device 10 is a main scanning direction, and a direction intersecting (orthogonal to or substantially orthogonal to) the main scanning direction is a sub-scanning direction.

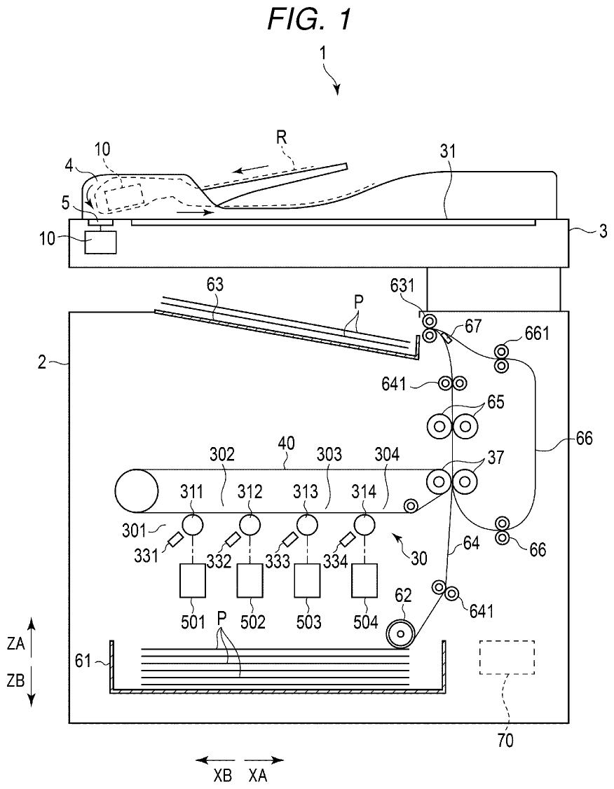

FIG. 1 is a schematic diagram of the image forming apparatus 1 according to the embodiment. The image forming apparatus 1 is a multi-function peripheral (MFP) integrating functions such as copying, scanning, and printing. The image forming apparatus 1 in an example is a solid-state scanning type LED copying machine including an exposure optical system in which a semiconductor light emitting element such as a LED is used as a light source. The image forming apparatus 1 includes a housing 2, a reading plate 3, and a scanner unit 4.

The reading plate 3 is supported by the housing 2 and is disposed above the housing 2 in the vertical direction. The reading plate 3 includes a reading surface 31 forming an upper surface of the reading plate 3. An object to be read is placed on the reading surface 31. The object to be read is, for example, a document. The reading surface 31 is, for example, an upper surface of a platen glass provided on the reading plate 3. The scanner unit 4 is disposed above the reading plate 3 in the vertical direction. The scanner unit 4 functions as a presser of the object to be read by pressing the object to be read placed on the reading surface 31 from above in the vertical direction.

The image forming apparatus 1 includes, inside the reading plate 3, the reading device 10 that reads information written on a surface to be read of the object to be read. The reading device 10 can move in the sub-scanning direction along the reading surface 31 by a driving mechanism (not shown). In the reading plate 3, a reading glass 5 is disposed side by side with the reading surface 31 in the sub-scanning direction of the reading device 10. The reading device 10 can be disposed below the reading glass 5 in the vertical direction. The reading device 10 is further provided inside the scanner unit 4. The reading device 10 provided in the scanner unit 4 does not move from a predetermined position of the scanner unit 4. In the scanner unit 4, the object to be read, such as a document, is conveyed along a conveyance path R in a conveyance direction indicated by arrows. A detailed configuration of the reading device 10 will be described later.

The image forming apparatus 1 includes an image forming unit 30 inside the housing 2. The image forming apparatus 1 includes a cylindrical intermediate transfer belt 40 above the image forming unit 30 in the vertical direction. The image forming unit 30 includes image forming portions 301 to 304 along the width direction of the image forming apparatus 1. In the embodiment, four colors of yellow, cyan, magenta, and black are used in the image forming portions. The image forming portions 301 to 304 respectively form yellow, cyan, magenta, and black images. The image forming portions 301 to 304 include photoconductor drums 311 to 314, developing devices 331 to 334, and exposure devices 501 to 504. Since the image forming portions 301 to 304 have the same configuration, the image forming portion 304 will be described, and descriptions of the image forming portions 301 to 303 having other colors will be omitted.

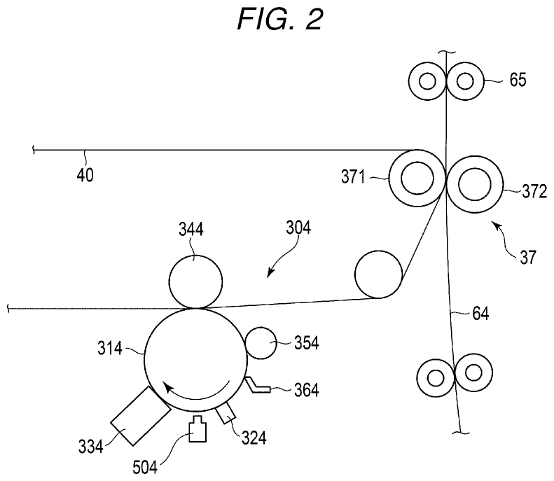

FIG. 2 is a schematic diagram showing a configuration of the image forming portion 304 that forms a black image and a configuration of a periphery thereof. The image forming portion 304 includes the photoconductor drum 314, a charger 324, the exposure device 504, the developing device 334, a primary transfer roller 344, a cleaner 354, and a blade 364. The photoconductor drum 314 can rotate about a rotation axis extending in the depth direction. The photoconductor drum 314 has an outer peripheral surface in contact with the intermediate transfer belt 40. The driving mechanism (not shown) of the image forming unit 30 rotates the photoconductor drum 314 in a direction of an arrow (clockwise direction). The photoconductor drum 314 rotates in contact with the intermediate transfer belt 40, thereby causing the intermediate transfer belt 40 to circulate.

The primary transfer roller 344 faces the photoconductor drum 314 at a portion on a lower side of the primary transfer roller 344 in the vertical direction with the intermediate transfer belt 40 interposed therebetween. The primary transfer roller 344 can rotate about a rotation axis extending in the depth direction. The primary transfer roller 344 has an outer peripheral surface in contact with an inner peripheral surface of the intermediate transfer belt 40. That is, the intermediate transfer belt 40 passes between the photoconductor drum 314 and the primary transfer roller 344 in the vertical direction and circulates.

The charger 324 uniformly charges a surface of the photoconductor drum 314. The exposure device 504 irradiates the surface of the photoconductor drum 314 with exposure light based on a color-separated black image signal. Accordingly, the exposure device 504 forms an electrostatic latent image based on an image signal for black on the surface of the photoconductor drum 314. The developing device 334 supplies black toner (developer) to the electrostatic latent image formed on the surface of the photoconductor drum 314 to form a black toner image on the surface of the photoconductor drum 314. The primary transfer roller 344 transfers the black toner image formed on the surface of the photoconductor drum 314 on the intermediate transfer belt 40 to be superimposed on toner images of other colors. The cleaner 354 and the blade 364 remove toner remaining on the surface of the photoconductor drum 314. The toner images of respective colors transferred to the surface of the intermediate transfer belt 40 in a superimposed manner move to between a pair of secondary transfer rollers 37 (371 and 372) by circulation of the intermediate transfer belt 40. In this case, the photoconductor drum 314 rotates, and the exposure device 504 writes the electrostatic latent image on the surface of the photoconductor drum 314. By rotating the photoconductor drum 314 by a certain amount, the exposure device 504 forms a color-separated electrostatic latent image for black corresponding to an entire image of the document on the surface of the photoconductor drum 314.

As shown in FIG. 1, the image forming apparatus 1 includes the pair of secondary transfer rollers 37 that transfer, to a sheet P, the toner images of the respective colors that are transferred to the surface of the intermediate transfer belt 40 in a superimposed manner. The secondary transfer roller 371 is one of rollers on which the intermediate transfer belt 40 is hung. The secondary transfer roller 372 faces the secondary transfer roller 371 with the intermediate transfer belt 40 interposed therebetween. The toner images of the respective colors transferred to the surface of the intermediate transfer belt 40 in a superimposed manner pass through a nip formed between the pair of secondary transfer rollers 37 by the circulation of the intermediate transfer belt 40.

The image forming apparatus 1 includes, in a lower portion of the inside of the housing 2 in the vertical direction, a sheet cassette 61 capable of housing plural sheets P of a predetermined size in a stacked manner. The sheet cassette 61 is, for example, pulled out from a front surface of the housing 2 in the depth direction and housed in the housing 2 toward a rear surface in the depth direction. The image forming apparatus 1 includes a pickup roller 62 that takes out the sheet P stored in the sheet cassette 61. The pickup roller 62 takes out the sheet P from the sheet cassette 61 one by one by rotating a peripheral surface thereof in contact with the sheet P.

The image forming apparatus 1 includes a sheet discharge tray 63 at an upper portion of the housing 2 in the vertical direction. The sheet discharge tray 63 is provided below the reading plate 3 in the vertical direction. In the image forming apparatus 1, a conveyance path 64 is provided between the pickup roller 62 and the sheet discharge tray 63. The conveyance path 64 conveys the sheet P taken out from the sheet cassette 61 toward the sheet discharge tray 63. The conveyance path 64 passes through the nip between the pair of secondary transfer rollers 37. In the conveyance path 64, plural pairs of conveyance rollers 641 are disposed, and a conveyance guide that guides conveyance of the sheet P may be disposed. The image forming apparatus 1 includes a pair of sheet discharge rollers 631 that discharge the sheet P to the sheet discharge tray 63 at an end portion of the conveyance path 64. The pair of sheet discharge rollers 631 can rotate in both a forward direction in which the sheet P is discharged to the sheet discharge tray 63 and a reverse direction in which the sheet P is returned to the conveyance path 64.

The image forming apparatus 1 includes a pair of fixing rollers 65. The pair of fixing rollers 65 are located above the pair of secondary transfer rollers 37 in the vertical direction. The conveyance path 64 is directed to the pair of sheet discharge rollers 631 through the pair of fixing rollers 65. The pair of fixing rollers 65 heat and pressurize the sheet P to be conveyed by the conveyance path 64 to fix the toner images transferred to a surface of the sheet P to the surface of the sheet P. The image forming apparatus 1 includes a reverse conveyance path 66 that reverses front and back of the sheet P on which the images are formed on one surface and conveys the sheet P to the nip between the pair of secondary transfer rollers 37. The reverse conveyance path 66 includes a pair of conveyance rollers 661 that rotate with the sheet P interposed therebetween and convey the sheet P. A conveyance guide (not shown) may be provided in the reverse conveyance path 66. The image forming apparatus 1 includes a gate 67 on a side opposite to the sheet discharge tray 63 side with respect to the pair of sheet discharge rollers 631 in the width direction. The gate 67 is disposed in the conveyance path 64, and switches a conveyance destination of the sheet P to the sheet discharge tray 63 or the reverse conveyance path 66.

The image forming apparatus 1 takes out the sheet P from the sheet cassette 61 by rotating the pickup roller 62. The image forming apparatus 1 conveys the sheet P taken out from the sheet cassette 61 toward the sheet discharge tray 63 via the conveyance path 64 by rotating the plural conveyance rollers 641. In this case, the image forming apparatus 1 transfers the toner images of the respective colors to the surface of the intermediate transfer belt 40 in accordance with a conveyance timing of the sheet P. The toner images are conveyed to the nip between the pair of secondary transfer rollers 37 by the circulation of the intermediate transfer belt 40. The image forming apparatus 1 applies a transfer voltage to the sheet P from the pair of secondary transfer rollers 37, and transfers the toner images of the respective colors to the surface of the sheet P. The image forming apparatus 1 conveys the sheet P to which the toner images are transferred to a nip between the fixing rollers 65. The image forming apparatus 1 heats and pressurizes the sheet P. Accordingly, the image forming apparatus 1 melts the toner images and presses the toner images against the surface of the sheet P, and fixes the toner images to the sheet P. The sheet P on which the images are fixed passes through the sheet discharge roller 631 and is discharged to the sheet discharge tray 63.

When a duplex mode for forming an image also on a back surface of the sheet P is selected, the image forming apparatus 1 switches a conveyance direction of the gate 67 to the reverse conveyance path 66 immediately before the sheet P discharged toward the sheet discharge tray 63 passes through the nip between the sheet discharge rollers 631. The image forming apparatus 1 reverses the sheet discharge roller 631 to convey the sheet P to the reverse conveyance path 66. After reversing the front and back of the sheet P, the image forming apparatus 1 conveys the sheet P to the nip between the pair of secondary transfer rollers 37 again. The image forming apparatus 1 forms toner images based on image data and formed on the back surface of the sheet P on the surface of the intermediate transfer belt 40. The image forming apparatus 1 runs the intermediate transfer belt 40 on which the toner images of the respective colors are formed and sends the toner images of the respective colors to the nip between the pair of secondary transfer rollers 37. As described above, the image forming apparatus 1 transfers and fixes the toner images to the back surface of the sheet P, and discharges the sheet P to the sheet discharge tray 63 via the sheet discharge roller 631.

The image forming apparatus 1 includes a controller 70 that controls operations of mechanisms described above. The controller 70 includes a processor such as a CPU and a memory. The controller 70 executes various processes by the processor executing a program stored in the memory. The controller 70 controls the reading device 10 to acquire an image from a surface to be read of the object to be read. The controller 70 controls the image forming unit 30 to form an image on the surface of the sheet P. In one example, the controller 70 inputs image data read by the reading device 10 to the image forming unit 30. The controller 70 controls operations of the conveyance rollers 641 and 661 to convey the sheet P through the conveyance path 64 and/or the reverse conveyance path 66. The controller 70 transfers and fixes the toner images based on the image data to the sheet P conveyed through the secondary transfer rollers 37 and the fixing rollers, and discharges the sheet P to the sheet discharge tray 63 through the sheet discharge roller 631.

In the image forming apparatus 1, when the reading device 10 reads the surface to be read of the object to be read, the reading device 10 irradiates the surface to be read with illumination light, so that illuminance of the surface to be read is set to illuminance sufficient for the reading device 10 to acquire an image. However, when the surface to be read is separated from the reading surface 31, illuminance may decrease in an image in which light reflected by the surface to be read is imaged on a sensor surface by a lens array. In this case, in the image acquired by the reading device 10, for example, a portion where the illuminance is insufficient is dark. Therefore, for example, when a distance between a document surface (surface to be read) and the reading surface varies depending on a place as in a book, or when the distance between the document surface and the surface to be read at a reading position varies when the document is conveyed at high speed using a document feeder, a difference in brightness occurs in a region where the brightness is originally uniform. In the reading device 10 of the embodiment, as will be described later, by setting a position where the illumination light illuminating the surface to be read has the maximum illuminance to a predetermined position, the brightness of the image in which the light reflected by the surface to be read is imaged on the sensor surface by the lens array can be made constant regardless of a degree to which the surface to be read is separated from the reading surface 31.

Hereinafter, the reading device 10 according to the embodiment will be described. The reading device 10 according to the embodiment can be provided in the reading plate 3 and/or the scanner unit 4. When the reading device 10 is provided in both of the reading plate 3 and the scanner unit 4, the image forming apparatus 1 can acquire an image of the surface to be read from the object to be read by controlling two reading devices 10. The reading device 10 according to the embodiment is a reading device using a contact image sensor (CIS). Therefore, the reading device 10 according to the embodiment does not use a reduction optical system.

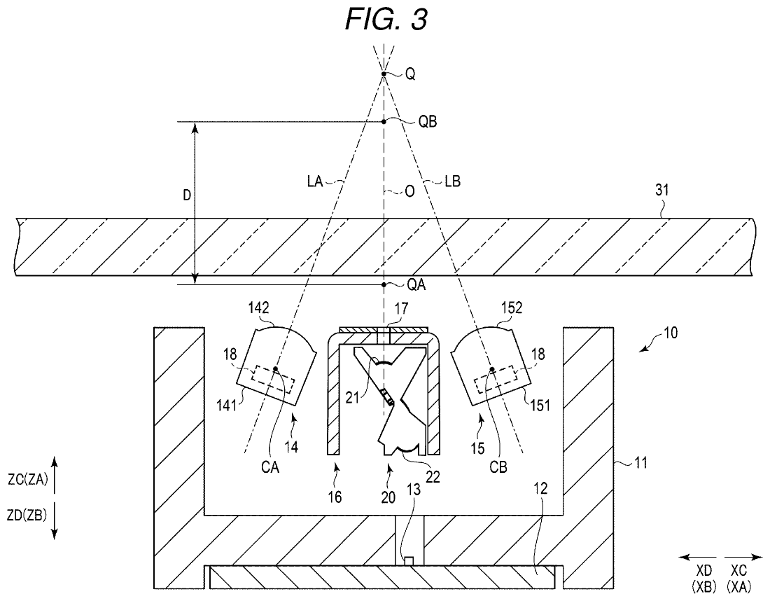

FIG. 3 is a schematic diagram showing a configuration of the reading device 10 provided in the reading plate 3 of the image forming apparatus 1 according to the embodiment and a configuration of a periphery thereof. In FIG. 3, similarly to FIG. 1, the vertical direction, the depth direction, and the width direction are defined. In the reading device 10, a direction intersecting (orthogonal to or substantially orthogonal to) both the main scanning direction and the sub-scanning direction (directions indicated by arrows XC and XD) is defined as a height direction (directions indicated by arrows ZC and ZD). The height direction of the reading device 10 coincides with or substantially coincides with the vertical direction. FIG. 3 shows the reading device 10 from one direction, the main scanning direction. The reading device 10 shown in FIG. 3 is provided inside the reading plate 3 of the image forming apparatus 1, and is disposed below the reading surface 31 in the height direction.

The reading device 10 includes a housing 11, a substrate 12, a sensor 13, light guides 14 and 15, a light shielding member 16, light sources 18, and a lens array 20. The housing 11 includes a pair of side walls extending in the main scanning direction and facing each other in the sub-scanning direction, and a partition wall extending between the pair of side walls in the sub-scanning direction. The partition wall is disposed above lower ends of the pair of side walls in the height direction. Therefore, the lower ends of the pair of side walls protrude downward from a lower surface of the partition wall in the height direction. Therefore, the housing 11 is formed in an H shape or a substantially H shape when projected in the main scanning direction. The substrate 12 is provided on the lower surface of the partition wall in the height direction, and is provided between the pair of side walls in the sub-scanning direction. The sensor 13 is mounted on the substrate 12. The sensor 13 is a line sensor in which imaging elements that convert light into electrical signals are arranged along the main scanning direction. The sensor 13 is one or plural line sensors. The sensor 13 is, for example, a charge coupled device (CCD) and a complementary metal oxide semiconductor (CMOS). A position where an image is formed by the lens array 20 to be described later is a sensor surface of the sensor 13.

The light guides 14 and 15 are a pair of optical elements that irradiate the reading surface 31 with illumination light (diffused light) emitted by the light sources 18. The light guides 14 and 15 extend along the main scanning direction. The light guides 14 and 15 are provided away from an upper surface of the partition wall of the housing 11 toward the reading surface 31 side in the height direction. The light guides 14 and 15 are disposed apart from each other in the width direction. In the embodiment, the light guides 14 and 15 have the same or substantially the same shape. The light guide 14 includes a diffusion portion 141 and an emission surface 142, and the light guide 15 includes a diffusion portion 151 and an emission surface 152. Since the light guides 14 and 15 have the same configuration, the light guide 14 will be described, and the description of the light guide 15 will be omitted.

The diffusion portion 141 diffuses illumination light incident on the light guide 14 from the light source 18 inside the light guide 14. In the embodiment, the illumination light is incident on the light guide 14 from an end portion in the main scanning direction. The diffusion portion 141 is formed on a lower surface of the light guide 14 in the height direction. The diffusion portion 141 may be, for example, a groove formed in the light guide 14, or may be formed of white ink applied to the light guide 14. The emission surface 142 is a surface from which the illumination light diffused by the diffusion portion 141 is emitted from the light guide 14. The emission surface 142 is formed along the main scanning direction (longitudinal direction) of the light guide 14 and faces the diffusion portion 141. That is, the emission surface 142 is formed on an upper surface of the light guide 14 in the height direction. In one example, the emission surface 142 is a cylindrical lens surface. A reflection plate may be attached to a surface of the diffusion portion 141. Alight source such as a LED may be provided on a surface of the diffusion portion 141.

The lens array 20 and the light shielding member 16 are provided between the pair of light guides 14 and 15 in the sub-scanning direction. The light shielding member 16 covers the lens array 20 from an outer side in the sub-scanning direction and from an upper side in the height direction. The lens array 20 and the light shielding member 16 extend along the main scanning direction. The pair of light guides 14 and 15 are adjacent to the light shielding member 16 from the outer side in the sub-scanning direction. The lens array 20 forms an image of the illumination light reflected by the surface to be read of the object to be read on the sensor 13. Therefore, the lens array 20 is disposed at a position where light emitted from the lens array 20 forms an image on the sensor 13.

The light shielding member 16 prevents light other than the reflected light from the surface to be read of the object to be read from being incident on the lens array 20. The light shielding member 16 includes a light shielding wall disposed between the lens array 20 and the reading surface 31 in the height direction, and a pair of light shielding side walls disposed between the lens array 20 and the light guides 14 and 15 in the sub-scanning direction. The light shielding wall extends between the pair of light shielding side walls in the sub-scanning direction. A slit 17 penetrating the light shielding wall in the height direction is formed in the light shielding wall of the light shielding member 16. The slit 17 is formed in the light shielding member 16 along the main scanning direction. The reflected light from the surface to be read passes through the slit 17 and is incident on the lens array 20 from the upper side in the height direction. Therefore, the slit 17 functions as a diaphragm in the sub-scanning direction.

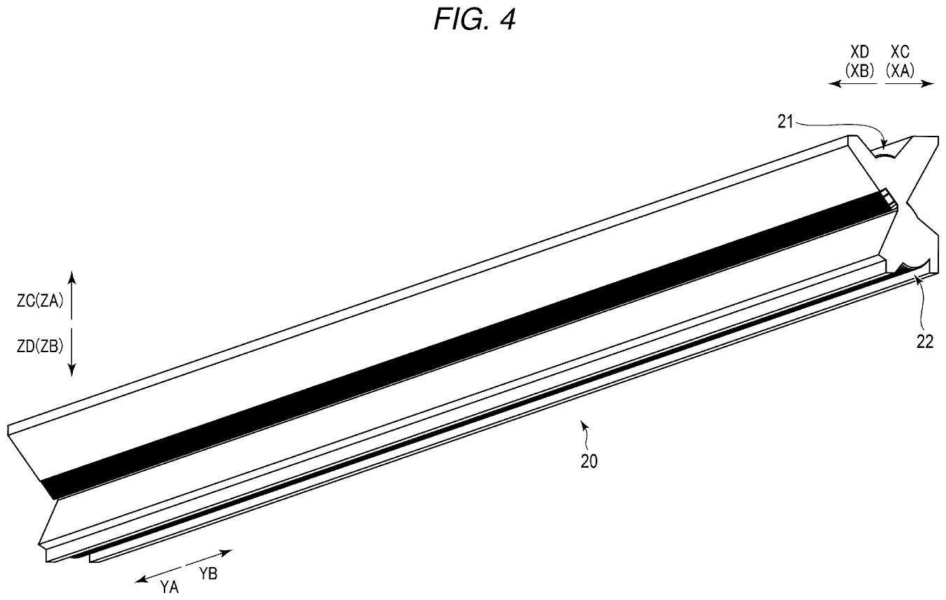

FIG. 4 is a perspective view of the lens array 20 provided in the reading device 10 according to the embodiment. Also in FIG. 4, similarly to FIG. 3, the main scanning direction, the sub-scanning direction, and the height direction are defined. The lens array 20 includes an incident surface 21 and an emission surface 22. The incident surface 21 is a surface on which the illumination light reflected by the surface to be read is incident on the lens array 20. The incident surface 21 is formed on, for example, a curved surface having a different (anisotropic) curvature at each portion of the incident surface 21, and functions as an incident side lens surface. An optical axis of the incident surface 21 extends along the height direction at a center of the incident surface 21 in the sub-scanning direction. The emission surface 22 is a surface that emits light incident on the lens array 20 and guided inside the lens array 20 toward the sensor 13 of the reading device 10. The emission surface 22 is formed on, for example, a curved surface having a different (anisotropic) curvature at each portion of the emission surface 22, and functions as an emission side lens surface. An optical axis of the emission surface 22 extends along the height direction at a center of the emission surface 22 in the sub-scanning direction. In the lens array 20, the optical axis of the incident surface 21 and the optical axis of the emission surface 22 are parallel or substantially parallel to each other.

The lens array 20 shown in FIG. 4 is an example, and a shape of the lens array 20 provided in the reading device 10 may be different from that shown in FIG. 4. For example, the lens array provided in the reading device 10 may be a rod lens array.

As shown in FIG. 3, the lens array 20 of the embodiment is provided in the reading device 10 in a posture in which the incident surface 21 is located on the reading surface 31 side in the height direction and the emission surface 22 is located on the sensor 13 side in the height direction. The lens array 20 is provided in the reading device 10 in a posture in which the optical axis of the incident surface 21 is along the height direction. Therefore, the optical axis of the incident surface 21 of the lens array 20 is orthogonal to or substantially orthogonal to the reading surface 31.

In the reading device 10 of the embodiment, the pair of light guides 14 and 15 locate the maximum illuminance of the illumination light illuminating the object to be read on a side opposite to the lens array 20 with respect to a deepest position of a depth of field of the lens array 20 in the height direction. The depth of field is a range of a position of a subject in which a lens sufficiently and clearly forms an image of the subject before and after a focal point of the lens on a side where the subject is located. That is, the depth of field is a range of a position of the surface to be read in which a lens sufficiently and clearly forms an image of the surface to be read before and after a focal point of the lens on a side where the surface to be read of the object to be read is located. In the reading device 10, the depth of field of the lens array 20 is a range D defined on the object to be read side from the incident surface 21 of the lens array 20 in the height direction. In the embodiment, a position of the depth of field closest to the incident surface 21 is defined as a closest position QA, and a position of the depth of field farthest from the incident surface 21 is defined as a deepest position QB. In FIG. 3, since the lens array 20 is disposed in the posture in which the optical axis of the incident surface 21 of the lens array 20 is along the height direction, the position of the depth of field closest to the incident surface 21 in the height direction is the closest position QA, and the position of the depth of field farthest from the incident surface 21 in the height direction is the deepest position QB.

The deepest position QB of the depth of field of the lens array 20 is appropriately set by the lens array 20 used in the reading device 10. In one example, the deepest position QB of the depth of field is set based on a range in which a modulation transfer function (MTF) of a 6 Lp/mmresolution chart (monochrome ladder chart) is 10% or more. In another example, the deepest position QB is set based on a range in which the MTF of a 6 Lp/mm MTF measurement chart (chart in which shading changes sinusoidally) is 55% or more.

In the reading device 10, a position where the illumination light by the light guides 14 and 15 has the maximum illuminance is located above the reading surface 31 in the height direction. The illuminance of the illumination light emitted from the light guides 14 and 15 to the reading surface 31 increases in the height direction from the light guides 14 and 15 toward the position where the illuminance is the maximum illuminance, and decreases in the height direction when the illumination light exceeds the position where the illuminance is the maximum illuminance. That is, the illuminance of the illumination light increases from the light guides 14 and 15 to the position where the illuminance is the maximum illuminance, and decreases when the illuminance light exceeds a position Q where the illuminance is the maximum illuminance. In the reading device 10, in a projection by the light guides 14 and 15 from the main scanning direction, straight lines LA and LB connecting curvature centers CA and CB of emission surfaces 142 and 152 of the light guides 14 and 15 and centers of diffusion portions 141 and 151 intersect an optical axis O of the lens array 20 that passes through a center of the incident surface of the lens array 20 at the position Q farther than the deepest position QB of the lens array 20 in the height direction. In the reading device 10, in the projection from the main scanning direction, the straight line LA in the light guide 14 intersects the straight line LB in the light guide 15 at the position Q on a side opposite to the lens array 20 with respect to the deepest position QB in the height direction.

The emission surfaces 142 and 152 of the light guides 14 and 15 preferably have curvatures such that light emitted from the emission surfaces 142 and 152 diffuses within a predetermined range. The light emitted from the emission surfaces 142 and 152 spreads in a direction intersecting the straight lines LA and LB from the emission surfaces 142 and 152 toward the reading surface 31. The curvatures of the emission surfaces 142 and 152 are smaller than a curvature at which the light emitted from the emission surfaces 142 and 152 is condensed, and is smaller than a curvature at which the maximum illuminance of the light emitted from the emission surfaces 142 and 152 is at the deepest position QB of the depth of field of the lens array 20. In one example, a separation distance between the emission surface 142 (152) and the diffusion portion 141 (151) facing the emission surface 142 (152) is larger than a radius of curvature of the emission surface 142 (152) and smaller than twice the radius of curvature of emission surface 142 (152). In FIG. 3, the separation distance is a maximum length of the light guide 14 (15) in a direction along the straight line LA (LB). By setting the curvatures of the emission surfaces 142 and 152 in this manner, the light guides 14 and 15 can appropriately adjust the illuminance of the illumination light.

The reading device 10 may be provided with only the light guide 14 or only the light guide 15. That is, the reading device 10 does not need to be provided with a pair of light guides, and may be provided with only one light guide. Also in this case, the light guide 14 or the light guide 15 provided in the reading device 10 locates the maximum illuminance of the illumination light illuminating the object to be read on the side opposite to the lens array 20 with respect to the deepest position QB of the depth of field of the lens array 20 in the height direction.

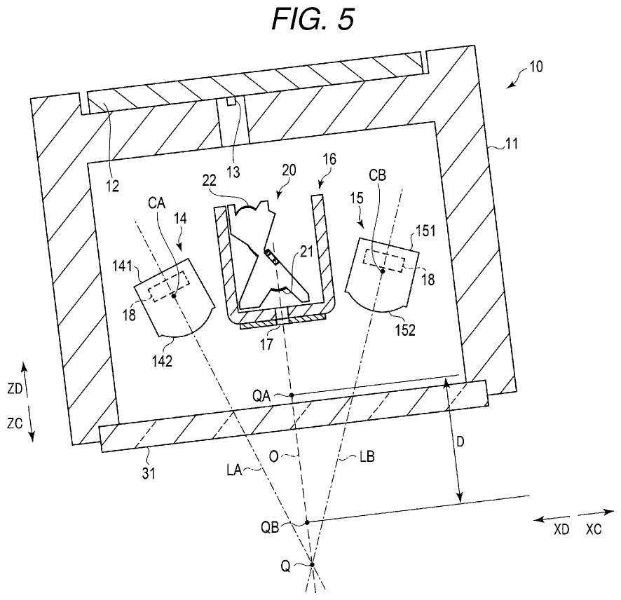

FIG. 5 is a schematic diagram when the reading device 10 is provided in the scanner unit 4. Also in FIG. 5, similarly to FIG. 3, the main scanning direction, the sub-scanning direction, and the height direction are defined. The sub-scanning direction of the reading device 10 coincides with or substantially coincides with the conveyance direction of the object to be read. When the reading device 10 is provided in the scanner unit 4, the reading device 10 includes the reading surface 31. The reading surface 31 is provided on a side opposite to the substrate 12 with respect to the lens array 20 in the height direction, and faces the substrate 12. In this case, the reading surface 31 is attached to the housing 11. A configuration of the reading device 10 is the same as a configuration when the reading device 10 is provided in the reading plate 3, except that the reading surface 31 is provided on the reading device 10 as described above. Since the object to be read is placed below the scanner unit 4 in the height direction, the reading device 10 is provided in the scanner unit 4 in a posture in which the reading surface 31 is located on a lower side of the reading device 10 in the height direction. That is, the reading device 10 is provided in the scanner unit 4 in a posture in which the reading device 10 is rotated by a predetermined angle about an axis along the main scanning direction from a posture in which the reading device 10 is provided in the reading plate 3.

When the reading device 10 acquires image information on the surface to be read of the object to be read by the scanner unit 4, the reading device 10 acquires the image information on the surface to be read without moving from a predetermined position of the scanner unit 4. In the embodiment, the object to be read is conveyed along a conveyance path provided inside the scanner unit 4, so that the surface to be read moves relative to the scanner unit 4. Accordingly, the reading device 10 can acquire the image information on the surface to be read at the predetermined position of the scanner unit 4.

In the reading device 10 according to the embodiment, illumination light emitted from the light source 18 is incident on the light guides 14 and 15. The illumination light incident on the light guides 14 and 15 is diffused inside the light guides 14 and 15 and by the diffusion portions 141 and 151, and is emitted from the emission surfaces 142 and 152 of the light guides 14 and 15. Since the light guides 14 and 15 are disposed in the reading device 10 as described above, the illumination light emitted from the emission surfaces 142 and 152 illuminates the reading surface 31. Accordingly, the surface to be read on a side opposite to the reading device 10 with respect to the reading surface 31 in the height direction is illuminated with the illumination light. The illumination light is reflected by the surface to be read, and then travels toward the reading surface 31 as reflected light. The reflected light passes through the reading surface 31 and the slit 17 and is incident on the lens array 20. In this case, since the slit 17 functions as a diaphragm of light incident on the lens array 20, a predetermined amount of light is incident on the lens array 20. The light incident on the lens array 20 from the incident surface 21 of the lens array 20 is reflected or the like inside the lens array 20, and is emitted from the emission surface 22 of the lens array 20. The light emitted from the emission surface 22 reaches the sensor 13. The sensor 13 receives the reflected light from the surface to be read, and acquires the image information on the surface to be read.

In the reading device 10 of the embodiment, the illuminance of the illumination light by the light source 18 is maximum on the side opposite to the lens array 20 in the height direction from the deepest position QB of the depth of field of the lens array 20. The illuminance of the illumination light increases from the lens array 20 toward the position where the illuminance of the illumination light is maximum in the height direction. Therefore, in the range D of the depth of field of the lens array 20, the illuminance in the image in which the light reflected by the object to be read is imaged on the sensor surface by the lens array when the surface to be read is separated from the reading surface in the height direction can be made equal to the illuminance when the surface to be read is not separated from the reading surface. That is, in the reading device 10 of the embodiment, when the object to be read and the reading surface are separated, it is possible to prevent a decrease in the illuminance in the image in which the light reflected by the object to be read is imaged on the sensor surface by the lens array. Therefore, in the image forming apparatus 1, the image information on the surface to be read can be appropriately acquired by the reading device 10.

In the reading device 10 of the embodiment, the light guides 14 and 15 are preferably the pair of light guides 14 and 15 adjacent to the lens array 20 from both outer sides of the lens array 20 in the sub-scanning direction. The pair of light guides 14 and 15 include the diffusion portions 141 and 151 that diffuse incident illumination light, and the emission surfaces 142 and 152 that are provided on a side opposite to the diffusion portions 141 and 151 in the height direction and have a predetermined curvature. In the projection from the main scanning direction, the straight lines LA and LB passing through the centers of the diffusion portions 141 and 151 and the curvature centers of the emission surfaces 142 and 152 in one of the pair of light guides 14 and 15 intersect the straight lines LA and LB passing through the centers of the diffusion portions 141 and 151 and the curvature centers of the emission surfaces in the other of the pair of light guides 14 and 15 on the side opposite to the lens array 20 with respect to the deepest position QB in the height direction. By disposing the light guides 14 and 15 in this manner, the illuminance in the range D of the depth of field of the lens array 20 can be further increased. Therefore, for example, the maximum illuminance of the illumination light can be set at a position further away from the deepest position QB of the depth of field of the lens array 20. Therefore, in the reading device 10, even when the object to be read and the reading surface 31 are separated, it is possible to prevent the decrease in the illuminance in the image in which the light reflected by the object to be read is imaged on the sensor surface by the lens array.

In the reading device 10 of the embodiment, the light guide 14 (15) includes the diffusion portion 141 (151) that diffuses the incident illumination light, and the emission surface 142 (152) that is provided on the side opposite to the diffusion portion 141 (151) in the height direction and has a predetermined curvature. In the projection from the main scanning direction, the straight line LA (LB) passing through the center of the diffusion portion 141 (151) and the curvature center of the emission surface 142 (152) intersects an axis of the optical axis O of the lens array 20 on the side opposite to the lens array 20 with respect to the deepest position QB in the height direction. By disposing the light guide 14 (15) in the reading device 10 in this manner, even when the object to be read and the reading surface 31 are separated, it is possible to prevent the decrease in the illuminance in the image in which the light reflected by the object to be read is imaged on the sensor surface by the lens array.

In the image forming apparatus 1 according to the embodiment, the reading device 10 according to the embodiment is preferably provided in the scanner unit 4 while the reading device 10 according to the embodiment is provided in the reading plate 3. In the image forming apparatus 1, for example, front and back surfaces of the object to be read are read by the same optical system. Therefore, hues of images on the front and back surfaces of the object to be read are the same or substantially the same. Therefore, when the object to be read is read, a difference in hue between the acquired images is small regardless of whether the reading plate 3 or the scanner unit 4 is used. Therefore, in the image forming apparatus 1, even when the object to be read is read by using either the reading plate 3 or the scanner unit 4, an image can be acquired with the same hue.

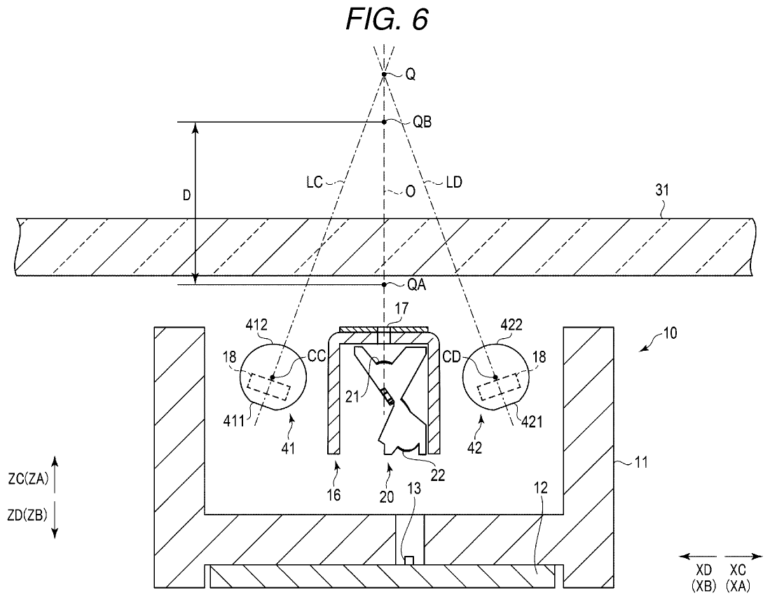

(Modification) FIG. 6 is a schematic diagram showing a modification of light guides 41 and 42 provided in the reading device 10. The configuration of the reading device 10 according to the modification is the same as that of the embodiment except that the shapes of the light guides 41 and 42 are different from those of the embodiment. The light guides 41 and 42 according to the modification are formed in a columnar shape extending in the main scanning direction. The light guides 41 and 42 include diffusion portions 411 and 421 and emission surfaces 412 and 422 as in the embodiment.

Unlike the light guide 14 (15) of the embodiment, in the light guide 41 (42) of the modification, a ridge portion extending in the main scanning direction is formed by the diffusion portion 411 (421) and the emission surface 412 (422). That is, the diffusion portion 411 (421) and the emission surface 412 (422) are adjacent to each other. Centers of the radii of curvature of the light guides 41 and 42 are points CC and CD. Also in this case, a maximum length of the light guide 41 (42) in a direction along the straight line LC (LD) is larger than the radius of curvature of the emission surface 412 (422) and smaller than twice the radius of curvature of the emission surface 412 (422). Therefore, also in the reading device 10 of the modification, the illuminance of the illumination light by the light source 18 is maximum on the side opposite to the lens array 20 with respect to the deepest position QB of the depth of field of the lens array 20 in the height direction. Therefore, the modification also implements the same functions and effects as those of the embodiment.

According to at least one of these embodiments, the light guide of the reading device is adjacent to the lens array in the sub-scanning direction intersecting both the height direction and the main scanning direction, and locates the maximum illuminance of the illumination light illuminating the object to be read on the side opposite to the lens array with respect to the deepest position of the depth of field of the lens array in the height direction. Accordingly, there is provided the reading device and the image forming apparatus capable of preventing the decrease in the illuminance in the image in which the light reflected by the object to be read is imaged on the sensor surface by the lens array when the object to be read and the reading surface are separated.

While embodiments have been described, the embodiments have been presented by way of examples only, and are not intended to limit the scope of the disclosure. Indeed, the novel embodiments described herein may be embodied in a variety of other forms, and various omissions, substitutions and changes may be made without departing from the spirit of the disclosure. The embodiments and modifications thereof are included in the scope and gist of the disclosure, and are also included in the inventions described in the claims and equivalents thereof.

What is claimed is:

1. A reading device that reads an object to be read in an image forming apparatus, comprising:
a lens array provided in a posture in which an optical axis follows a height direction intersecting a reading surface; and
alight guide adjacent to the lens array in a sub-scanning direction intersecting both the height direction and a main scanning direction, the light guide configured to locate maximum illuminance of illumination light illuminating the object to be read on a side opposite to the lens array with respect to a deepest position of a depth of field of the lens array in the height direction.

2. The reading device according to claim 1, wherein
the light guide comprises a pair of light guides adjacent to the lens array from both outer sides of the lens array in the sub-scanning direction,
each of the pair of light guides comprises a diffusion portion that diffuses incident illumination light, and an emission surface provided on a side opposite to the diffusion portion in the height direction and has a predetermined curvature, and
in projection from the main scanning direction, a straight line passing through a center of the diffusion portion and a curvature center of the emission surface in one of the pair of light guides intersects a straight line passing through a center of the diffusion portion and a curvature center of the emission surface in the other of the pair of light guides on the side opposite to the lens array with respect to the deepest position in the height direction.

3. The reading device according to claim 1, wherein
the light guide comprises a diffusion portion that diffuses incident illumination light, and an emission surface provided on a side opposite to the diffusion portion in the height direction and has a predetermined curvature, and
in projection from the main scanning direction, a straight line passing through a center of the diffusion portion and a curvature center of the emission surface intersects an axis of the optical axis of the lens array on the side opposite to the lens array with respect to the deepest position in the height direction.

4. The reading device according to claim 1, further comprising:
a light source configured to emit the illumination light incident on the light guide; and
a sensor provided on a side opposite to the reading surface with respect to the lens array in the height direction, the sensor configured to receive reflected light obtained by reflecting the illumination light by the object to be read.

5. The reading device according to claim 4, wherein the sensor is a charge coupled device or a complementary metal oxide semiconductor.

6. The reading device according to claim 1, wherein a depth of field of the lens array has a range defined on the object to be read side from an incident surface of the lens array in the height direction.

7. The reading device according to claim 1, wherein a position where illumination light by the light guide has the maximum illuminance above a reading surface in the height direction.

8. The reading device according to claim 1, wherein illuminance of the illumination light increases from the light guide to a position where the illuminance is the maximum illuminance, and illuminance of the illumination light decreases when the illuminance light exceeds a position where the illuminance is the maximum illuminance.

9. The reading device according to claim 1, wherein the object is a paper document.

10. An image forming apparatus comprising:
the reading device according to claim 1;
a photoconductor drum configured to form an electrostatic latent image based on an image acquired by the reading device; and
a developing device configured to develop the electrostatic latent image of the photoconductor drum with a developer.

11. A scanning device, comprising:
a reading plate; and
a reading device that reads an object to be read, comprising:
a lens array provided in a posture in which an optical axis follows a height direction intersecting a reading surface; and
a light guide adjacent to the lens array in a sub-scanning direction intersecting both the height direction and a main scanning direction, the light guide configured to locate maximum illuminance of illumination light illuminating the object to be read on a side opposite to the lens array with respect to a deepest position of a depth of field of the lens array in the height direction.

12. The scanning device according to claim 11, wherein
the light guide comprises a pair of light guides adjacent to the lens array from both outer sides of the lens array in the sub-scanning direction,
each of the pair of light guides comprises a diffusion portion that diffuses incident illumination light, and an emission surface provided on a side opposite to the diffusion portion in the height direction and has a predetermined curvature, and
in projection from the main scanning direction, a straight line passing through a center of the diffusion portion and a curvature center of the emission surface in one of the pair of light guides intersects a straight line passing through a center of the diffusion portion and a curvature center of the emission surface in the other of the pair of light guides on the side opposite to the lens array with respect to the deepest position in the height direction.

13. The scanning device according to claim 11, wherein
the light guide comprises a diffusion portion that diffuses incident illumination light, and an emission surface provided on a side opposite to the diffusion portion in the height direction and has a predetermined curvature, and
in projection from the main scanning direction, a straight line passing through a center of the diffusion portion and a curvature center of the emission surface intersects an axis of the optical axis of the lens array on the side opposite to the lens array with respect to the deepest position in the height direction.

14. The scanning device according to claim 11, further comprising:
a light source configured to emit the illumination light incident on the light guide; and
a sensor provided on a side opposite to the reading surface with respect to the lens array in the height direction, the sensor configured to receive reflected light obtained by reflecting the illumination light by the object to be read.

15. The scanning device according to claim 14, wherein the sensor is a charge coupled device or a complementary metal oxide semiconductor.

16. The scanning device according to claim 11, wherein a depth of field of the lens array has a range defined on the object to be read side from an incident surface of the lens array in the height direction.

17. The scanning device according to claim 11, wherein a position where illumination light by the light guide has the maximum illuminance above a reading surface in the height direction.

18. The scanning device according to claim 11, wherein illuminance of the illumination light increases from the light guide to a position where the illuminance is the maximum illuminance, and illuminance of the illumination light decreases when the illuminance light exceeds a position where the illuminance is the maximum illuminance.

19. The scanning device according to claim 11, wherein the object is a paper document.

20. An image forming apparatus comprising:
the scanning device according to claim 11;
a photoconductor drum configured to form an electrostatic latent image based on an image acquired by the reading device; and
a developing device configured to develop the electrostatic latent image of the photoconductor drum with a developer.
